(19) United States
(12) Patent Application Publication
(10) Pub. No.: US 2014/0369697 A1
(43) Pub. Date: Dec. 18, 2014

(54) TRANSMISSION DEVICE AND TRANSMISSION METHOD

(71) Applicant: FUJITSU LIMITED, Kawasaki-shi (JP)

(72) Inventor: Tsutomu Tsurumi, Kawasaki (JP)

(73) Assignee: FUJITSU LIMITED, Kawasaki-shi (JP)

(21) Appl. No.: 14/222,814

(22) Filed: Mar. 24, 2014

(30) Foreign Application Priority Data
Jun. 17, 2013 (JP) 2013-126761

(51) Int. Cl. H04B 10/508

(52) U.S. Cl. CPC H04B 10/508
USPC 398/182

(57) ABSTRACT

A transmission device that receives a main signal, the transmission device includes: a receiver configured to receive, from a different transmission device corresponding to a source device of the main signal, a control signal including setting information concerning the main signal; a frame processing section configured to process a frame of the main signal; and a first controller configured to set the frame processing section in accordance with the setting information.

### CROSS-REFERENCE TO RELATED APPLICATION

This application is based upon and claims the benefit of priority of the prior Japanese Patent Application No. 2013-126761, filed on Jun. 17, 2013, the entire contents of which are incorporated herein by reference.

### FIELD

The embodiments discussed herein are related to a transmission device and a transmission method.

### BACKGROUND

The number of types of main signals transmitted in networks has increased. In backbone networks, in addition to synchronous optical network (SONET) signals and synchronous digital hierarchy (SDH) signals, signals such as Ethernet (registered trademark) signals are transmitted. Optical transport network (OTN) signals based on regulations of International Telecommunication Union Telecommunication Standardization Sector (ITU-T) recommendation G.709 have also become widespread.

Each type of signal has a variety of frame formats and transmission speeds. For example, SONET has a synchronous transfer signal (STS)-3, an STS-12, an STS-48, an STS-192, and an STS-768. SDH has a synchronous transfer mode (STM)-1, an STM-4, an STM-16, an STM-64, and an STM-256. Ethernet includes 1 GbE (gigabit Ethernet) and 10 GbE.

A related technique is disclosed in Japanese Laid-open Patent Publication No. 5-130058.

### SUMMARY

According to an aspect of the invention, a transmission device that receives a main signal, the transmission device includes: a receiver configured to receive, from a different transmission device corresponding to a source device of the main signal, a control signal including setting information concerning the main signal; a frame processing section configured to process a frame of the main signal; and a first controller configured to set the frame processing section in accordance with the setting information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a network of a transmission device;

FIG. 2 illustrates an example of a reconfigurable optical add and drop multiplexer (ROADM) device;

FIG. 3 illustrates an example of a format of a control signal;

FIG. 4A illustrates examples of a signal identification number;

FIG. 4B illustrates examples of a forward error correction (FEC) identification number;

FIG. 5 illustrates an example of each of terminal devices;

FIGS. 6A and 6B illustrate an example of waveforms of spectra associated with a method for detecting a control signal;

FIGS. 7A and 7B illustrate an example of a waveform of spectra associated with a method for detecting a control signal;

FIGS. 8A and 8B illustrate an example of a waveform of spectra associated with a method for detecting a control signal;

FIG. 9 illustrates an example of a processes performed in a terminal device on a transmitting side and a terminal device on a receiving side among the terminal devices; and

FIG. 10 illustrates an example of a network of a transmission device.

### DESCRIPTION OF EMBODIMENTS

A main signal is relayed by a plurality of transmission devices included in a network, and transmitted from a transmission device on a transmitting-station side to a transmission device on a receiving-station side. A network management device that monitors and controls the network performs signal setting in accordance with the type of main signal on the transmission device on the transmitting-station side and the transmission device on the receiving-station side so that the type of main signal on the transmitting-station side and the type of main signal on the receiving-station-side will match.

For example, one of the terminal devices modulates the main signal using a modulated sub-carrier that is different from the main signal, and transmits a monitoring control signal to individual relays.

Regarding signal setting for the transmission devices, an operator inputs setting information for each line in the network management device, whereby signal setting is performed for the transmission devices. Diversification of the type of main signal causes signal setting to become complicated, and a task of signal setting may take time and effort.

If the operator performs signal setting and, consequently, sets an incorrect setting, the type of signal on the transmitting-station side and the type of signal on the receiving-station side do not match. Thus, for example, a warning about a loss of frame synchronization (loss of frame (LOF)) is output on the receiving-station side. In this case, in the network management device, it may be difficult to distinguish whether a failure corresponding to an output condition of the warning has occurred or an incorrect signal setting has been performed.

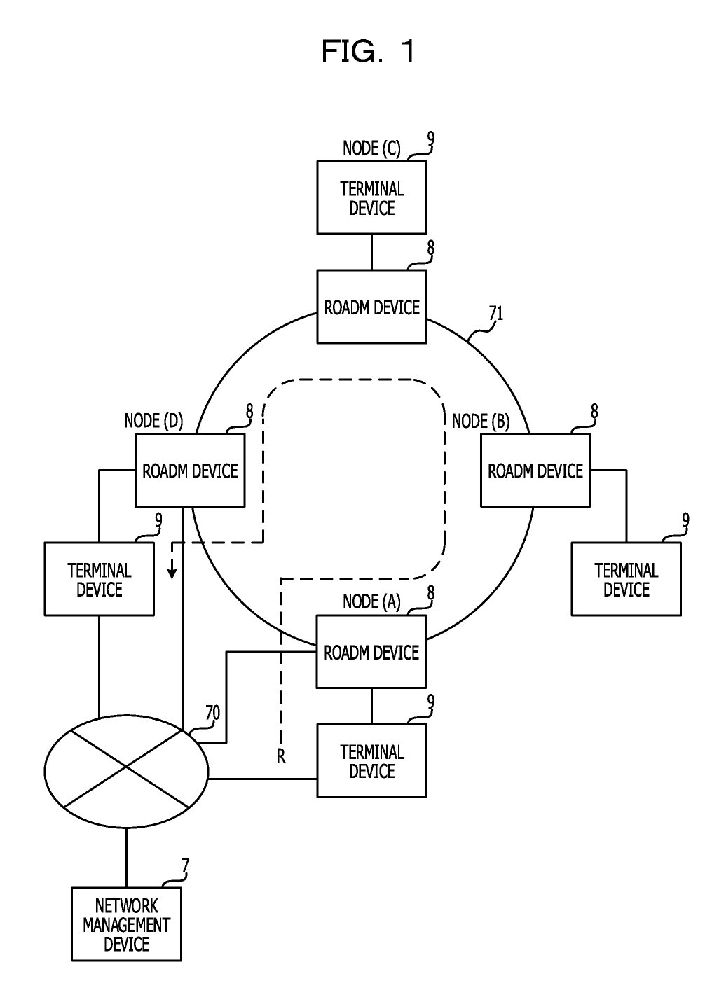

FIG. 1 illustrates an example of a network of a transmission device. The network (a transmission system) includes nodes (A) to (D) which are coupled via a transmission path (optical fibers) 71 to each other so as to constitute a ring network. The shape of the network is not limited to a ring shape, and may be another shape such as a mesh shape. The number of nodes is also not limited thereto.

At each of the nodes (A) to (D), a ROADM device 8 and a terminal device (transmission device) 9 are provided. The terminal device 9 receives a client signal from another network, and outputs the client signal as a main signal to the ROADM device 8. A main signal is input from the ROADM device 8 to the terminal device 9, and the terminal device 9 transmits the main signal as a client signal to another network.

The ROADM device 8 multiplexes a plurality of optical signals having different wavelengths into a multiplexed optical signal, and transmits the multiplexed optical signal, which has been obtained by multiplexing. The ROADM device 8 transmits, as a multiplexed optical signal, a main signal that has been input from the terminal device 9. The multiplexed optical signal is input via the transmission path 71 to the ROADM device 8 that is provided at an adjacent node. A relay device for the main signal may be each of the ROADM devices 8, and may be another type of relay device such as a repeater that simply amplifies an optical signal.

The ROADM devices 8 and the terminal devices 9 that are provided at the individual nodes (A) to (D) are coupled via a management network 70 to a network management device 7. The network management device 7 monitors and controls the ROADM devices 8 and the terminal devices 9 that are provided at the individual nodes (A) to (D). As the management network 70, for example, a local area network (LAN) may be used. For example, although, referring to FIG. 1, the network management device 7 is coupled to the nodes (A) to (D), the network management device 7 may be coupled to only some of the nodes.

The network management device 7 sets a path for a main signal for the individual nodes (A) to (D). For example, in the case of transmitting a main signal from the terminal device 9 provided at the node (A) via the nodes (B) and (C) to the terminal device 9 provided at the node (D) (see a path R), the network management device 7 sets an insertion setting (an add setting) in the ROADM device 8 provided at the node (A). The network management device 7 sets a pass-through setting (a through setting) in the ROADM device 8 provided at the nodes (B) and (C). The network management device 7 sets a branch setting (a drop setting) in the ROADM device 8 provided at the node (D). In this case, the node (A) functions as a transmitting station, and the node (D) functions as a receiving station.

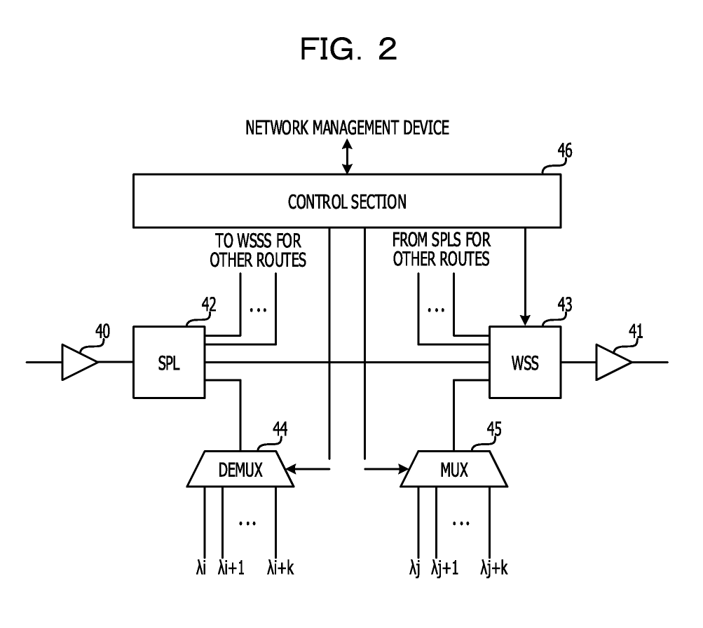

FIG. 2 illustrates an example of a reconfigurable optical add and drop multiplexer (ROADM) device. The ROADM device 8 includes a control section 46, optical amplifiers 40 and 41, and an optical splitter (SPL) 42, a wavelength selective switch (WSS) 43, a demultiplexing section (DEMUX) 44, and a multiplexing (MUX) section 45. In FIG. 2, the optical amplifiers 40 and 41, the optical splitter 42, and the wavelength selective switch 43 for one route are illustrated. However, a configuration substantially the same as or similar to the configuration illustrated in FIG. 2 may be provided for other routes.

The optical amplifier 40 amplifies a multiplexed optical signal that has been input from the transmission path 71, and outputs the amplified multiplexed optical signal to the optical splitter 42. The optical splitter 42 causes the multiplexed optical signal to branch off, and leads the multiplexed optical signal to the wavelength selective switch 43 and the demultiplexing section 44. The wavelength selective switch 43, which corresponds to a destination of the multiplexed optical signal which branches off, receives a signal from illustrated route and a signal from other routes.

The demultiplexing section 44 may be, for example, an array waveguide grating (AWG). The demultiplexing section 44 demultiplexes the multiplexed optical signal into an optical signal having a wavelength λi, an optical signal having a wavelength λi+1, . . . , and an optical signal having a wavelength λi+k, and outputs the optical signals, which have been obtained by demultiplexing, from individual ports. At least one of the optical signal having a wavelength λi, the optical signal having a wavelength λi+1, . . . , and the optical signal having a wavelength λi+k is output to the terminal device 9. The wavelengths λi, λi+1, . . . , and λi+k are set on a port-by-port basis by the control section 46.

The control section 46 may be a processor such as a central processing unit (CPU), and performs overall control of the ROADM device 8. The control section 46 communicates with the network management device 7, and performs wavelength setting on the wavelength selective switch 43, the demultiplexing section 44, and the multiplexing section 45 in accordance with an instruction provided by the network management device 7.

The multiplexing section 45 may be, for example, an AWG. The multiplexing section 45 combines the optical signals having the wavelengths λi, λi+1, . . . , and λi+k, which have been input to the individual ports, into a combined optical signal, and outputs the optical signal to the wavelength selective switch 43. The wavelengths λi, λi+1, . . . , and λi+k are set on a port-by-port basis by the control section 46. At least one of the optical signal having the wavelength λi, the optical signal having the wavelength λi+1, . . . , and the optical signal having the wavelength λi+k is input from the terminal device 9.

The wavelength selective switch 43 multiplexes, into a multiplexed optical signal, optical signals having a wavelength that has been selected in accordance with the setting that is set by the control section 46, and outputs the multiplexed optical signal to the optical amplifier 41. For example, the wavelength selective switch 43 separates, on a wavelength-by-wavelength basis, multiplexed optical signals that have been input from the optical splitters 42 for the individual routes and the multiplexing section 45. The wavelength selective switch 43 multiplexes optical signals having the selected wavelength into a multiplexed optical signal, and outputs the multiplexed optical signal. The optical amplifier 41 amplifies the multiplexed optical signal, and outputs the amplified multiplexed optical signal to the transmission path 71.

The control section 46 sets a wavelength in the wavelength selective switch 43, the demultiplexing section 44, and the multiplexing section 45, whereby the insertion setting, the pass-through setting, and the branch setting may be set. In the case of transmitting a signal having a wavelength λs along the path R illustrated in FIG. 1, at the node (A), in order to set the insertion setting for the wavelength λs, the control section 46 sets the wavelength λs in the wavelength selective switch 43 and the multiplexing section 45. At the nodes (B) and (C), in order to set the pass-through setting for the wavelength λs, the control section 46 sets the wavelength λs in the wavelength selective switch 43. At the node (D), in order to set the branch setting for the wavelength λs, the control section 46 sets the wavelength λs in the demultiplexing section 44, and a block setting (a non-selection setting) for the wavelength λs in the wavelength selective switch 43.

In this manner, appropriate settings are performed on the ROADM devices 8 provided at the individual nodes (A) to (D). Accordingly, a main signal is transmitted between terminal devices 9 among the terminal devices 9. Each of the terminal devices 9 may select one type of main signal from among a plurality of types of main signals, and may transmit the one type of main signal. Thus, in order to correctly transmit and receive a main signal, settings may be set, in a terminal device 9 on the transmitting side which transmits the main signal and a terminal device 9 on a receiving side which receives the main signal, so that the types of main signals will match.

Each of the terminal devices 9 may select, as FEC used to perform error correction on data of a main signal, one type of FEC from among a plurality of types of FECs. In order to correctly perform error correction, settings may be performed on the terminal device 9 on the transmitting side and the terminal device 9 on the receiving side so that the types of FECs will match.

Information concerning the type of main signal and the type of FEC is included in a control signal, and is transmitted from the terminal device 9 on the transmitting side to the terminal device 9 on the receiving side. The control signal may be superimposed on a main signal that is to be transmitted. Thus, for example, along the path R illustrated in FIG. 1, the control signal is transmitted from the terminal device 9 provided at the node (A) via the ROADM devices 8 provided at the nodes (A) to (D) to the terminal device 9 provided at the node (D).

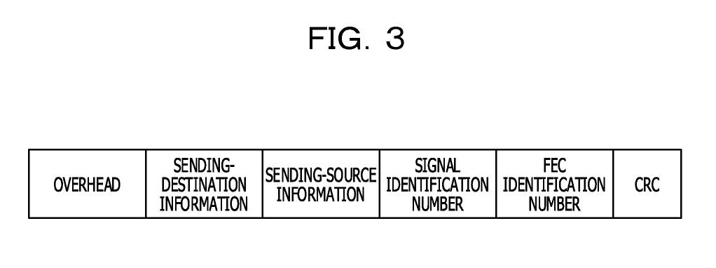

FIG. 3 illustrates an example of a format of a control signal. The control signal includes an overhead, transmitting-destination information, transmitting-source information, a signal identification number, an FEC identification number, and a cyclic redundancy check (CRC).

The overhead is a fixed data pattern by which the control signal is identified by the terminal devices 9. As the fixed data pattern, the overhead may be, for example, 0x5A5A, or may be another pattern.

The transmitting-destination information is information indicating a terminal device 9 on the transmitting side among the terminal devices 9, and the transmitting-source information is information indicating a terminal device 9 on the receiving side among the terminal devices 9. The transmitting-destination information and the transmitting-source information may include, for example, station information (for example, a symbol such as “TKYFUJITSU-20130529”) and device information (for example, a symbol such as “OS1-OYAMA-K1”).

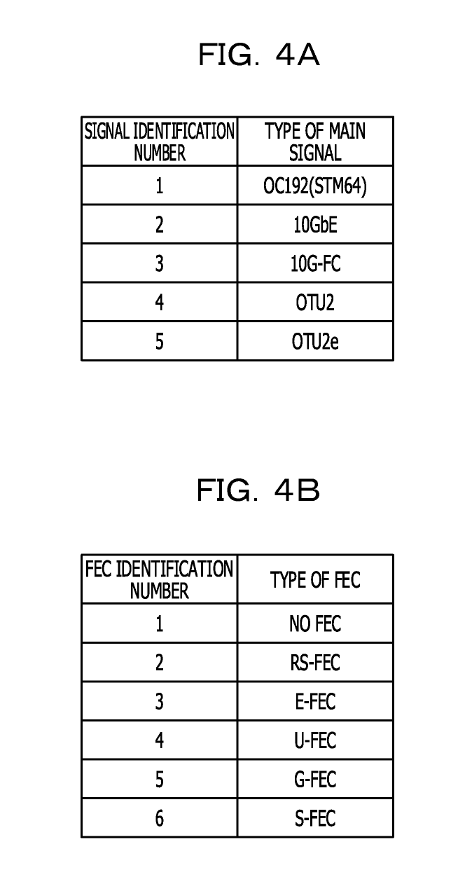

The signal identification number is information indicating the type of main signal. The FEC identification number is information indicating the type of FEC. FIG. 4A illustrates an example of a signal identification number. FIG. 4B illustrates an example of a FEC identification number.

In FIG. 4A, types of main signals corresponding to signal identification numbers are illustrated. For example, when the signal identification number is “1”, the type of main signal may be “OC192 (STM64)”. When the signal identification number is “2”, the type of main signal may be “10 GbE”.

The signal identification number may be set so that the type of frame of a main signal and the transmission speed of the main signal are determined. For example, “10 GbE” represents an Ethernet frame for 10-Gbps Ethernet. The type of frame and the transmission speed may be indicated by an identification number in another format.

In FIG. 4B, types of FECs corresponding to FEC identification numbers are illustrated. For example, when the FEC identification number is “1”, FEC is not applied (see “NO”). When the FEC identification number is “2”, the type of FEC may be reed solomon (RS) FEC. For example, the types of FEC that are defined in Appendix I of ITU-T recommendation G.975 may be used.

The CRC illustrated in FIG. 3 is an error correction code for data of the control signal. For example, the normality of data of the control signal may be checked using the CRC, and an error of about several bits may be corrected.

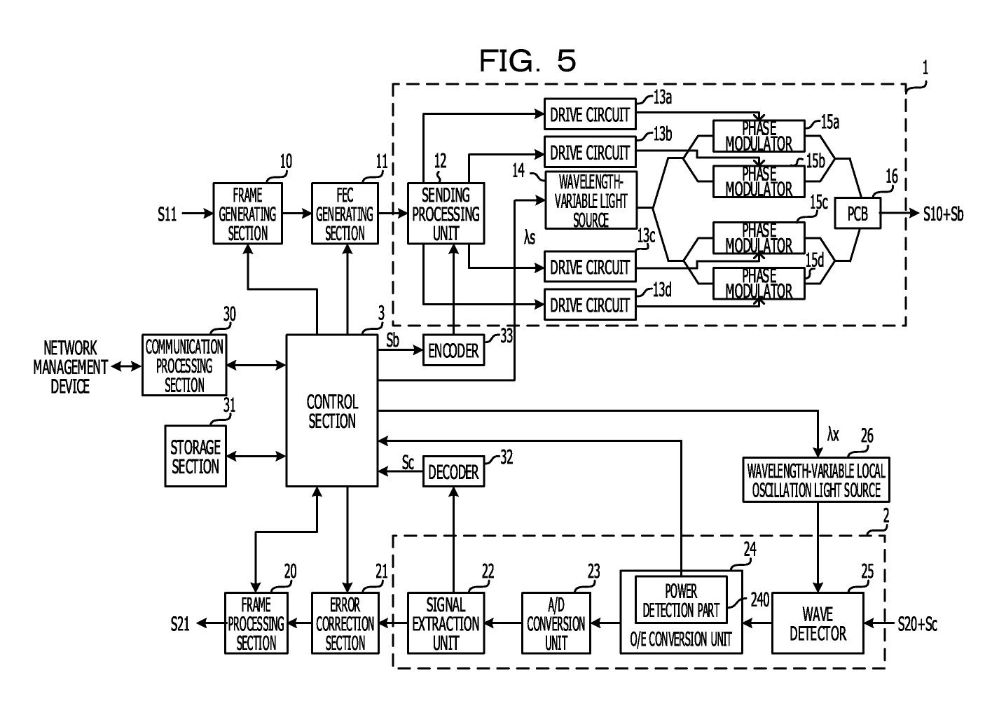

FIG. 5 illustrates an example of a terminal device. The terminal device 9 includes a transmitting section 1, a receiving section 2, a control section 3, an encoder 33, a decoder 32, a communication processing section 30, a storage section 31, a frame generating section 10, an FEC generating section 11, a frame processing section 20, an error correction section 21, and a wavelength-variable local oscillation light source 26.

The frame generating section 10 receives a client signal S11 from an external network, and generates a frame of a main signal S10 based on the client signal S11. For example, the frame generating section 10 stores data of the client signal S11 in the frame of the main signal S10. Any format may be used as the format of the client signal S11.

The FEC generating section (error-correction-code generating section) 11 generates an error correction code that is to be used to correct an error in data of the main signal S10. The generated FEC may be added to, for example, the last portion of the data of the main signal S10.

The transmitting section 1 superimposes a control signal Sb on the main signal S10, and transmits the main signal S10. The main signal S10 on which the control signal Sb is superimposed is input to the multiplexing section 45 of the corresponding ROADM device 8.

The receiving section 2 receives a main signal S20 on which a control signal Sc is superimposed. For example, the receiving section 2 receives the control signal Sc that is superimposed on the main signal S20 from the demultiplexing section 44 of the ROADM device 8.

The error correction section 21 checks an error in data of the main signal S20 based on FEC included in the main signal S20. When an error is detected as a result of checking, the error correction section 21 corrects, using FEC, the error.

The frame processing section 20 processes the frame of the received main signal S20. For example, the frame processing section 20 performs a synchronization process on the frame of the main signal S20. After that, the frame processing section 20 obtains data from the frame of the main signal S20, and transmits the data as a client signal S21 to an external network. When frame synchronization is not established due to a failure in the transmission path 71, the frame processing section 20 notifies the control section 3 of LOF as a warning.

The control section 3 may be, for example, a CPU and a field programmable gate array (FPGA), and performs overall control of the terminal device 9. The communication processing section 30 processes communication between the control section 3 and the network management device 7. The storage section 31 may be, for example, a memory, and stores a program used to drive the control section 3, various types of setting information, and so forth.

The control section 3 receives, from the network management device 7, a signal identification number (setting information) of the main signal S10 that is a target to be sent and an FEC identification number (code-type information) indicating the type FEC that is to be applied to the main signal S10, and stores the signal identification number and the FEC identification number in the storage section 31.

The control section 3 reads the signal identification number from the storage section 31, and sets the frame generating section 10 in accordance with the signal identification number. Thus, the frame generating section 10 may generate a frame corresponding to the signal identification number (see FIG. 4A).

The control section 3 reads the FEC identification number from the storage section 31, and sets the FEC generating section 11 in accordance with the FEC identification number. Thus, the FEC generating section 11 may generate FEC corresponding to the FEC identification number (see FIG. 4B).

The control section 3 generates the control signal Sb including the signal identification number and the FEC identification number. The control signal Sb is encoded by the encoder 33, and, then, is output to the transmitting section 1.

The transmitting section 1 superimposes the control signal Sb on the main signal S10, and transmits the main signal S10 on which the control signal Sb is superimposed. The transmitting section 1 includes a transmitting processing unit 12, drive circuits 13a to 13d, and a wavelength-variable light source 14, phase modulators 15a to 15d, and a polarization beam combiner (PCB) 16.

The transmitting processing unit 12 modulates the main signal S10, and superimposes the main signal S10 on a main carrier. The transmitting processing unit 12 superimposes the encoded control signal Sb on a sub-carrier that is different from the main carrier. The transmitting processing unit 12 combines the main carrier and the sub-carrier into a combined wave, and controls the drive circuits 13a to 13d based on the combined wave. Thus, the control signal Sb is superimposed on the main signal S10. As a modulation scheme, for example, discrete multitone technique (DMT) may be used, or another modulation scheme may be used.

The control signal Sb is superimposed on the main signal S10. Thus, the main signal S10 and the control signal Sb are sent to the terminal device 9 on the receiving side via the transmission path 71 that is used in common by a transmitting process that is used in common.

The wavelength-variable light source 14 outputs a transmitting light beam whose wavelength is variable. The wavelength λs of the transmitting light beam may be set by the control section 3. The control section 3 receives the wavelength λs from the network management device 7, and stores the wavelength λs in the storage section 31.

The phase modulators 15a to 15d may be, for example, LN modulators. The phase modulators 15a to 15d are driven by the drive circuits 13a to 13d, respectively, thereby modulating the phase of the transmitting light beam. The phase modulators 15a to 15d are coupled each other using optical waveguides so as to constitute a Mach-Zehnder interferometer. Thus, four light beams having different phases are generated. The polarization beam combiner 16 combines the phases of the four light beams to obtain a signal, and outputs the obtained signal as an optical signal including the main signal S10 and the control signal Sb. The optical signal is input to the multiplexing section 45 of the ROADM device 8.

The control signal Sb including the signal identification number and the FEC identification number is superimposed on the main signal S10, and is output to the transmission path 71 by the ROADM device 8. For example, along the path R illustrated in FIG. 1, in the ROADM device 8 provided at the node (A), the main signal S10 and the control signal Sb are inserted, and output to the transmission path 71. In this case, the insertion for the wavelength λs is set in the ROADM device 8 provided at the node (A).

The control signal Sc is sent, to a different terminal device 9 that is a transmitting destination of the main signal S10 among the terminal devices 9, for example, a terminal device 9 on the receiving side. Along the path R illustrated in FIG. 1, the main signal S10 and the control signal Sc are caused to branch off in the ROADM device 8 provided at the node (D), and input to the receiving section 2 of the terminal device 9. The branch for the wavelength λs is set in the ROADM device 8 provided at the node (D).

The receiving section 2 includes a signal extraction unit 22, an analog-to-digital (A/D) conversion unit 23, an optical-electrical (O/E) conversion unit 24, and a wave detector 25. The wave detector 25 detects, using a reference light beam output from the wavelength-variable local oscillation light source 26, the main signal S20 and the control signal Sc. As a wave detection scheme used by the wave detector 25, for example, homodyne detection may be used. Another scheme such as heterodyne detection may be used.

The O/E conversion unit 24 converts an optical signal output from the wave detector 25 into an electric signal. The O/E conversion unit 24 includes a power detection part 240 that detects power (an optical level) of the optical signal output from the wave detector 25. The power detection part 240 notifies the control section 3 of the detected power.

While the control section 3 is monitoring the power of which the control section 3 is notified from the power detection part 240, the control section 3 controls a wavelength λx of the reference light beam output from the wavelength-variable local oscillation light source 26. The control section 3 adjusts the wavelength λx so that the power of the optical signal output from the wave detector 25 becomes the maximum power.

The A/D conversion unit 23 converts the electric signal from an analog signal into a digital signal. The signal extraction unit 22 separates the main carrier and the sub-carrier from each other, thereby extracting a component of the control signal Sc from the electric signal. The signal extraction unit 22 outputs the component of the control signal Sc to the decoder 32. The signal extraction unit 22 demodulates a component of the main signal S20, and outputs the component of the main signal S20 to the error correction section 21.

The decoder 32 decodes the control signal Sc, and outputs the control signal Sc to the control section 3. The control section 3 identifies the control signal Sc by the overhead (see FIG. 3). When the control signal Sc is identified, the control section 3 checks, using the CRC, an error in the data of the control signal. When an error of several bits is detected, the control section 3 corrects the error.

The control section 3 compares, for example, the transmitting-destination information, with an ID that is stored in the storage section 31 and that is an ID of the terminal device 9 including the control section 3 which is a subject of description. When the transmitting-destination information matches the ID, the control section 3 performs setting processes on the error correction section 21 and the frame processing section 20. The control section 3 transmits, for example, the transmitting-source information to the network management device 7.

The control section 3 sets the error correction section 21 based on the FEC identification number included in the control signal Sc. Thus, the error correction section 21 may correctly process the FEC based on a setting that matches the setting of the terminal device 9 on the transmitting side, for example, without incorrectly detecting an error in data.

The control section 3 sets the frame processing section 20 in accordance with the signal identification number included in the control signal Sc. Thus, the frame processing section 20 may correctly process the frame of the main signal S20 based on a setting that matches the setting of the terminal device 9 on the transmitting side, for example, without incorrectly detecting LOF. When the network management device 7 is notified of LOF from the terminal device 9, the network management device 7 may easily determine that the settings which have been performed does not have any problem but the transmission path 71 has a problem. For example, determination of a factor in a failure may become easy.

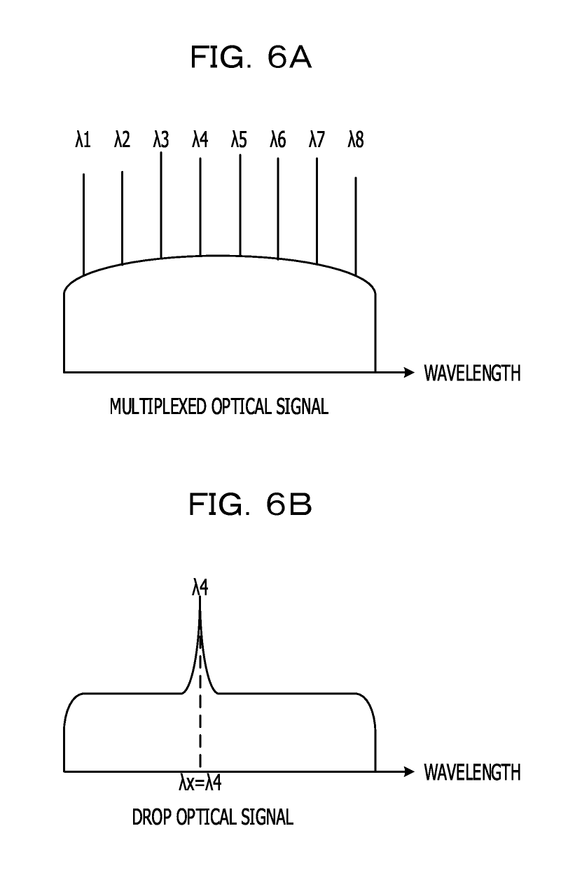

FIGS. 6A and 6B illustrate an example of a spectrum waveform associated with a method for detecting a control signal. In FIGS. 6A and 6B, a method for detecting the control signal Sc is illustrated. For example, in a terminal device 9 on the receiving side among the terminal devices 9, the wavelength λx of the control signal Sc may be known. In this case, for example, the network management device 7 may acquire the wavelength λx of the control signal Sc, for example, the above-described wavelength λs from a terminal device 9 on the transmitting side among the terminal devices 9, and may notify, in advance, the terminal device 9 on the receiving side of the wavelength λx.

FIG. 6A illustrates a waveform of an optical spectrum of a multiplexed optical signal that is transmitted along the transmission path 71. The multiplexed optical signal may include, for example, optical signals having wavelengths λ1 to λ8. The wavelength of the control signal Sc may be λ4.

FIG. 6B illustrates a waveform of an optical spectrum of a drop optical signal that is input from the demultiplexing section 44 of the corresponding ROADM device 8. The control section 3 adjusts the wavelength λx of the reference light beam to the known wavelength λ4 of the control signal Sc. In this case, the wave detector 25 outputs beat light. Thus, the power detection part 240 detects the maximum power. For example, the amplitude may be the largest. When the control section 3 is notified of the maximum power from the power detection part 240, the control section 3 determines that the control signal Sc has been detected, and sets the frame processing section 20 and the error correction section 21 in accordance with the signal identification number and the FEC identification number.

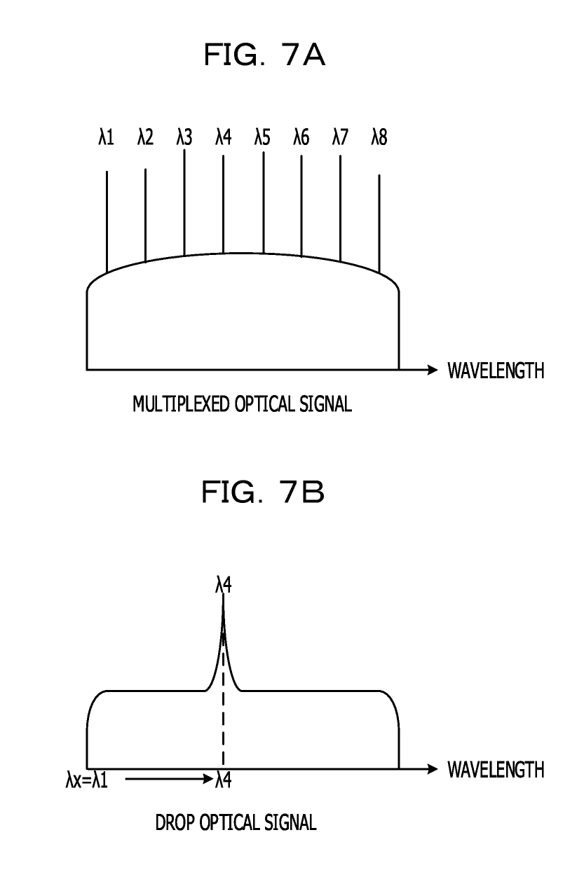

FIGS. 7A and 7B illustrate an example of a spectrum waveform associated with a method for detecting a control signal. In FIGS. 7A and 7B, a method for detecting the control signal Sc is illustrated. For example, in the terminal device 9 on the receiving side, the wavelength λx of the control signal Sc may be unknown.

FIG. 7A illustrates a waveform of an optical spectrum of a multiplexed optical signal that is transmitted along the transmission path 71. The multiplexed optical signal may include, for example, optical signals having the wavelengths λ1 to λ8. The wavelength of the control signal Sc may be λ4.

FIG. 7B illustrates a waveform of an optical spectrum of a drop optical signal that is input from the demultiplexing section 44 of the ROADM device 8. The control section 3 increases the wavelength λx of the reference light beam from the minimum usable wavelength λ1 by a certain wavelength interval Δλ, for example, by a unit defined in the ITU-T grid. For example, the wavelength λx may be sequentially changed so as to be λ1, λ1+Δλ, λ1+2×Δλ, . . . . The wavelength may be changed, for example, after a certain time period has elapsed. The wavelength λx may be changed in a direction in which the wavelength λx is increased from the minimum wavelength λ i, or may be changed in a direction in which the wavelength λx is reduced from the maximum wavelength λ8.

When the wavelength λx has been adjusted to λ4, the wave detector 25 outputs beat light. Thus, power detection part 240 detects the maximum power. When the control section 3 is notified of the maximum power from the power detection part 240, the control section 3 determines that the control signal Sc has been detected, and sets the frame processing section 20 and the error correction section 21 in accordance with the signal identification number and the FEC identification number. For example, when the power of which the control section 3 is notified from the power detection part 240 becomes equal to or larger than a certain value, the control section 3 may determine that the power is the maximum power.

The control section 3 may control the wavelength of the reference light beam so that the power of the control signal Sc becomes equal to or larger than the certain value. Thus, even when the wavelength λx of the control signal Sc is unknown, the control signal Sc may be detected on the terminal device 9 on the receiving side.

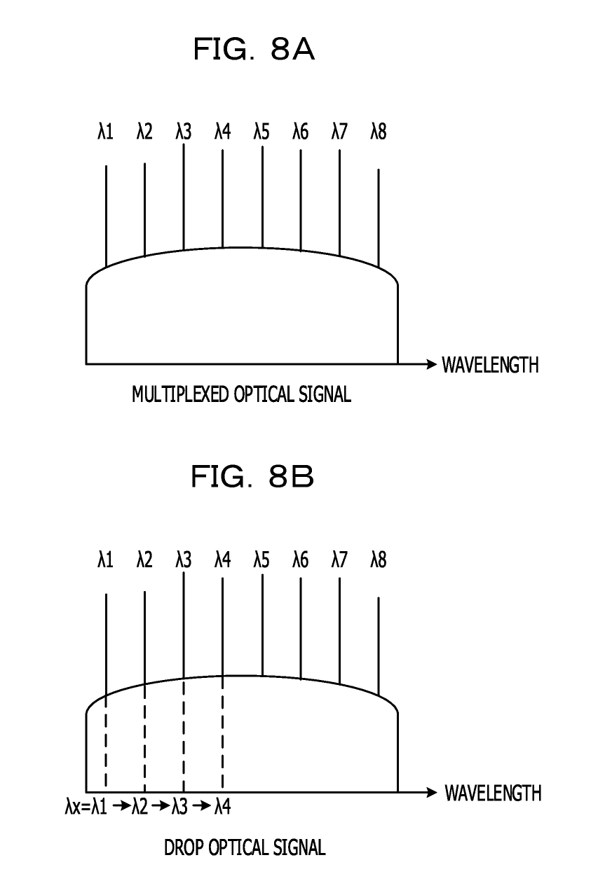

FIGS. 8A and 8B illustrate an example of a spectrum waveform associated with a method for detecting a control signal. In FIGS. 8A and 8B, a method for detecting the control signal Sc is illustrated. For example, in the terminal device 9 on the receiving side, the wavelength λx of the control signal Sc may be unknown. Furthermore, the ROADM device 8 may have a colorless function. In the colorless function, in order to increase convenience in wavelength setting, restrictions imposed on wavelengths for the ports may be removed in the multiplexing section 45 and the demultiplexing section 44. For example, an optical signal having any wavelength may be input to each of the ports of the multiplexing section 45. Optical signals having all wavelengths included in a multiplexed optical signal may be output from the individual ports of the demultiplexing section 44. For example, in the colorless function, as the multiplexing section 45 and the demultiplexing section 44, for example, an optical coupler and an optical splitter, respectively, may be used.

FIG. 8A illustrates a waveform of an optical spectrum of a multiplexed optical signal that is transmitted along the transmission path 71. The multiplexed optical signal may include, for example, optical signals having the wavelengths λ1 to λ8. For example, the wavelength of the control signal Sc whose destination is the terminal device 9 on the receiving side may be λ4. The other wavelengths λ1 to λ3 and λ5 to λ9 may be the wavelengths of the control signals Sc whose destinations are other terminal devices 9.

FIG. 8B illustrates a waveform of an optical spectrum of a drop optical signal that is input from the demultiplexing section 44 of the ROADM device 8. In the drop optical signal, components of all of the wavelengths (λ1 to λ8) of the multiplexed optical signal may be included by the colorless function.

The control section 3 increases the wavelength λx of the reference light beam from the minimum usable wavelength λ1 by a certain wavelength interval Δλ (for example, a unit defined in the ITU-T grid). For example, the wavelength λx may be sequentially changed so as to be λ1, λ1+Δλ, λ1+2×Δλ, . . . . The wavelength may be changed, for example, after a certain time period has elapsed. The wavelength λx may be changed in a direction in which the wavelength λx is increased from the minimum wavelength λ1, or may be changed in a direction in which the wavelength λx is reduced from the maximum wavelength λ8.

Every time the wavelength λx is adjusted to any one of the wavelengths λ1 to λ8, the wave detector 25 outputs beat light. Thus, the power detection part 240 detects the maximum power. When the control section 3 is notified of the maximum power from the power detection part 240, the control section 3 determines that the control signal Sc has been detected. The control section 3 compares transmitting-destination information (see FIG. 3) included in the control signal Sc with the ID of the terminal device 9.

As a result of comparison, when the transmitting-destination information matches the ID, the control section 3 sets the frame processing section 20 and the error correction section 21 in accordance with the signal identification number and the FEC identification number. For example, when the power of which the control section 3 is notified from the power detection part 240 becomes equal to or lager than a certain value, the control section 3 may determine that the power is the maximum power. As a result of comparison, when the transmitting-destination information does not match the ID, the control section 3 continues control of the wavelength λx without setting the frame processing section 20 and the error correction section 21.

Based on the colorless function, regarding the receiving section 2 of the terminal device 9, when not only the control signal Sc whose destination is the terminal device 9 but also the control signals Sc whose destinations are other terminal devices 9 are input to the receiving section 2 of the terminal device 9, the control section 3 determines, based on the transmitting-destination information included in the control signal Sc, the control signal Sc whose destination is the terminal device 9. Thus, convenience in wavelength setting and convenience in signal setting may be improved.

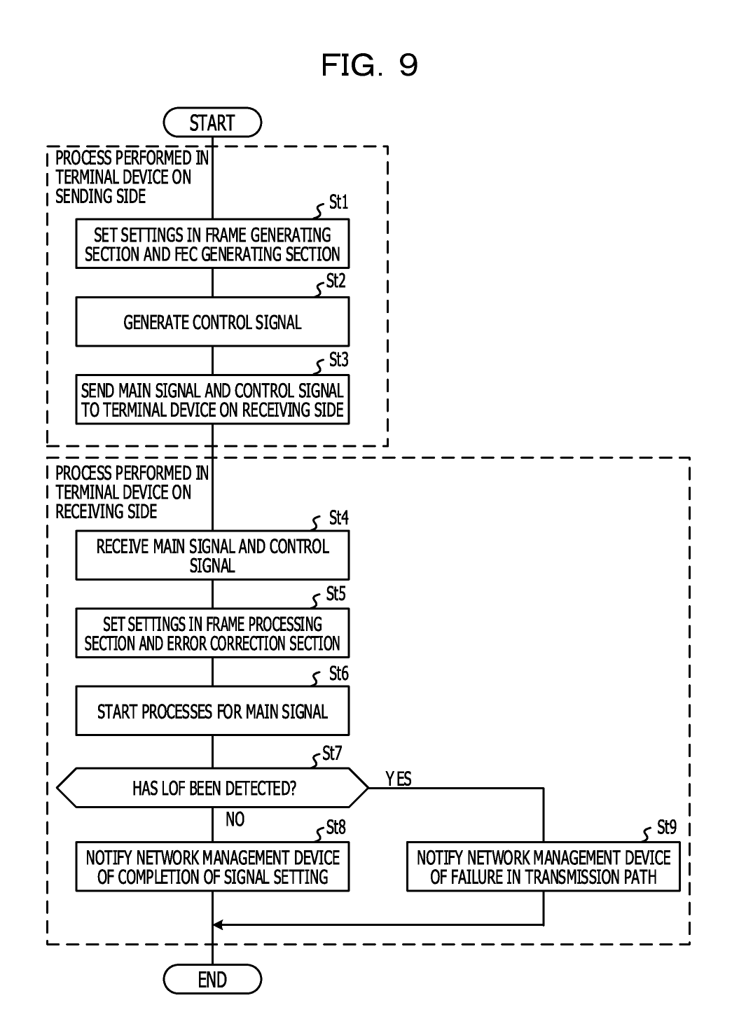

FIG. 9 illustrates an example of processes of a terminal device on a transmitting side and a terminal device on a receiving side. In FIG. 9, processes performed in a terminal device 9 on the transmitting side and a terminal device 9 on the receiving side among the terminal devices 9 are illustrated. For example, in FIG. 9, a procedure of starting conduction of a main signal between the terminal device 9 on the transmitting side and the terminal device 9 on the receiving side is illustrated. For example, along the path R illustrated in FIG. 1, the terminal device 9 on the transmitting side may be the terminal device 9 provided at the node (A), and the terminal device 9 on the receiving side may be the terminal device 9 provided at the node (D). In FIG. 9, operations St1 to St3 indicate processes performed in the terminal device 9 on the transmitting side, and operations St4 to St9 indicate processes performed in the terminal device 9 on the receiving side.

In the terminal device 9 on the transmitting side, the control section 3 sets the frame generating section 10 and the FEC generating section 11 in accordance with a signal identification number and an FEC identification number received from the network management device 7 (operation St1). Thus, the frame generating section 10 generates a frame of the main signal S10 corresponding to the signal identification number. The FEC generating section 11 generates FEC corresponding to the FEC identification number.

The control section 3 generates a control signal Sc (see FIG. 3) that includes the signal identification number and the FEC identification number (operation St2). The transmitting section 1 transmits the main signal S10 and the control signal Sc to the terminal device 9 on the receiving side (operation St3). The control signal Sc is superimposed on the main signal S10, and the control signal Sc superimposed on the main signal S10 is transmitted.

In the terminal device 9 on the receiving side, the receiving section 2 receives the main signal S20 and a control signal (operation St4). In order to detect a control signal, the control section 3 may perform any one of the processes associated with FIGS. 6 to 8.

The control section 3 sets the frame processing section 20 and the error correction section 21 in accordance with the signal identification number and the FEC identification number that are included in the control signal (operation St5). The frame processing section 20 is set so as to match the setting of the frame generating section 10 of the terminal device 9 on the transmitting side. The error correction section 21 is set so as to match the setting of the FEC generating section 11 of the terminal device 9 on the transmitting side.

The frame processing section 20 and the error correction section 21 start processes for the main signal (operation St6). In this case, the frame processing section 20 processes the frame of the main signal S20 based on the type of main signal indicated by the signal identification number. The error correction section 21 processes FEC based on the type of FEC indicated by the FEC identification number, and performs error correction. An instruction to start the processes for the main signal is output from the control section 3 to the frame processing section 20 and the error correction section 21.

The frame processing section 20 and the error correction section 21 start the processes for the main signal, after the signal identification number and the FEC identification number have been set. Thus, a warning about LOF or the like and an error in data may be not necessarily incorrectly detected.

The control section 3 determines whether or not LOF has been detected (operation St8). When LOF has been detected (YES in operation St7), the control section 3 notifies the network management device 7 of a failure in the transmission path 71 (operation St9). When LOF is not detected (NO in operation St7), the control section 3 notifies the network management device 7 of completion of signal setting (operation St8). For example, when LOF is detected, the control section 3 clearly determines a factor in the failure, and notifies the network management device 7 of the factor. In this manner, the processes in the terminal device 9 on the transmitting side and the terminal device 9 on the receiving side are performed.

The control signal may be superimposed on the main signal. The control signal superimposed on the main signal may be transmitted along the path R that is common to the control signal and the main signal, or may be transmitted along a path different from the path along which the main signal is transmitted.

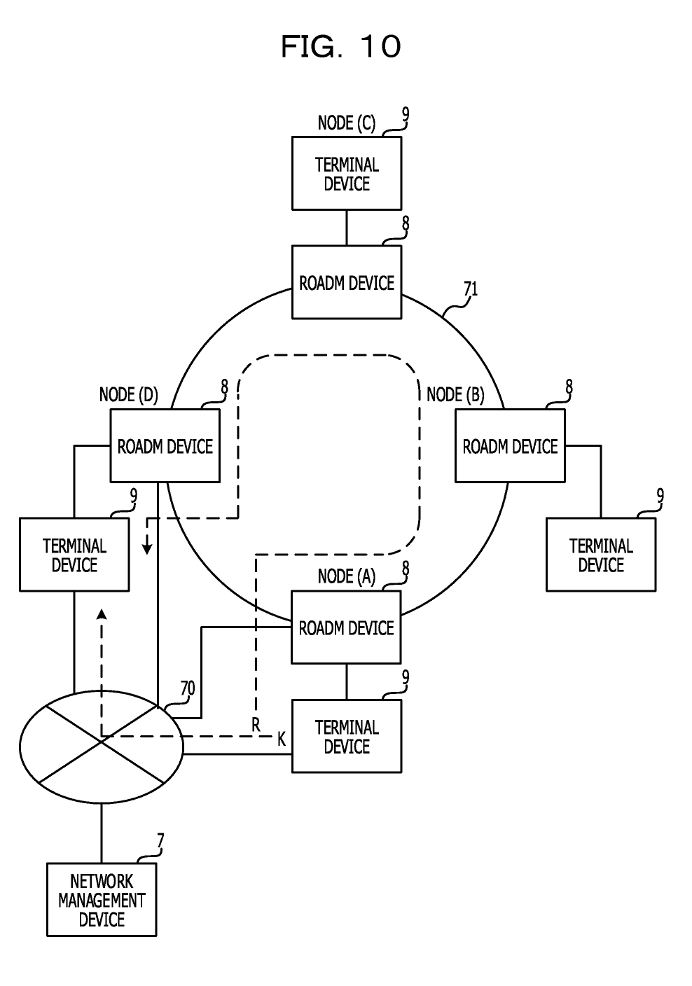

FIG. 10 illustrates an example of a network of transmission devices. In FIG. 10, components that are substantially the same as or similar to the components illustrated in FIG. 1 are denoted by the same reference numerals, and a description thereof may be omitted or reduced.

The terminal device 9 provided at the node (A) transmits a main signal along the path R to the terminal device 9 provided at the node (D). For example, the main signal may be transmitted from the node (A) via the nodes (B) and (C) to the node (D).

A control signal is transmitted, to the node (D), along a path K different from the path R along which the main signal is transmitted. For example, the terminal device 9 provided at the node (A) transmits the control signal via the management network 70 to the terminal device 9 provided at the node (D). In this case, in the terminal device 9 illustrated in FIG. 5, the communication processing section 30 may function as a transmitting section that transmits a control signal or a receiving section that receives a control signal.

The terminal device 9 provided at the node (A) transmits the control signal as, for example, an Ethernet frame. In this case, the control signal is led, in accordance with a destination address (DA) of the Ethernet frame, to the terminal device 9 provided at the node (D). Instead of the DA, the control signal may be led based on transmitting-destination information included in the control signal. The terminal device 9 provided at the node (D) determines, based on the transmitting-destination information included in the control signal, that the control signal is a signal whose destination is the terminal device 9 provided at the node (D).

In order to transmit a control signal from a terminal device 9 on the transmitting side to a terminal device 9 on the receiving side among the terminal devices 9, a setting similar to the setting of the terminal device 9 on the transmitting side may be set in the terminal device 9 on the receiving side in accordance with a signal identification number and an FEC identification number that are included in the control signal. Also in FIG. 10, effects that are substantially the same as or similar to the effects obtained in the network illustrated in FIG. 1 may be obtained.

A transmission device, for example, a terminal device 9 on the receiving side among the terminal devices 9 includes the receiving section 2, the frame processing section 20, and the control section 3, and receives the main signal S20. The receiving section 2 receives the control signal Sc including setting information concerning the main signal S20, for example, a signal identification number of the main signal S20, from a different transmission device that is a transmitting source of the main signal S20, for example, from a terminal device 9 on the transmitting side among the terminal devices 9. The frame processing section 20 processes the frame of the received main signal S20. The control section 3 sets the frame processing section 20 in accordance with the setting information.

The receiving section 2 receives the control signal Sc including the setting information concerning the main signal S20 from the different transmission device 9 that is a transmitting source of the main signal S20. The control section 3 sets the frame processing section 20 in accordance with the setting information. The frame processing section 20 processes the frame of the received main signal based on a setting substantially the same as the setting of the different transmission device 9 which is a transmitting source of the main signal S20.

Thus, mismatch between the setting of the above-mentioned transmission device 9 and the setting of the different transmission device 9 which transmits the main signal S20 is reduced. The main signal may be correctly processed without detecting a warning about LOF or the like. Signal setting may be facilitated.

A transmission device, for example, a terminal device 9 on the transmitting side among the terminal devices 9 includes the frame generating section 10, the control section 3, and the transmitting section 1, and transmits the main signal S10. The frame generating section 10 generates the frame of the main signal S10. The control section 3 sets the frame generating section 10 in accordance with setting information concerning the main signal S10, for example, a signal identification number, and generates the control signal Sb including the setting information. The transmitting section 1 transmits the control signal Sb to a different transmission device that is a transmitting destination of the main signal S10, for example, a terminal device 9 on the transmitting side among the terminal devices 9.

The frame generating section 10 is set by the control section 3 in accordance with the setting information concerning the main signal S10. The control section 3 generates the control signal Sb including the setting information. The transmitting section 1 transmits the control signal Sb to the different terminal device that is a transmitting destination of the main signal S10.

Mismatch between the setting of the above-mentioned transmission device 9 and the setting of the different transmission device 9 which receives the main signal S10 is reduced. Signal setting may be facilitated.

A transmission system includes a first transmission device that transmits a main signal, for example, a terminal device 9 on the transmitting side among the terminal devices 9, and a second transmission device that receives the main signal, for example, a terminal device 9 on the receiving side among the terminal devices 9.

The first transmission device 9 includes the frame generating section 10, a first control section 3, and the transmitting section 1. The frame generating section 10 generates a frame of a main signal. The first control section 3 sets the frame generating section 10 in accordance with setting information concerning the main signal, for example, a signal identification number. The first control section 3 generates the control signal Sc including the setting information. The transmitting section 1 transmits the control signal Sc to the second transmission device, for example, the terminal device 9 on the receiving side.

The second transmission device 9 includes the receiving section 2, the frame processing section 20, and the control section 3. The receiving section 2 receives the control signal Sc including the setting information concerning the main signal from the first transmission device 9. The frame processing section 20 processes the frame of the received main signal. The control section 3 sets the frame processing section 20 in accordance with the setting information.

The above-described transmission system has a configuration substantially the same as or similar to the configuration of the transmission device 9 illustrated in FIG. 1 or 5. Thus, effects substantially the same as or similar to the above-described effects may be achieved.

In a transmission method, a main signal is transmitted from a first transmission device including the frame generating section 10 that generates a frame of the main signal, for example, a terminal device 9 on the transmitting side among the terminal devices 9, to a second transmission device including the frame processing section 20 that processes the frame of the main signal, for example, a terminal device 9 on the receiving side among the terminal devices 9. In this transmission method, the first transmission device 9 sets the frame generating section 10 in accordance with setting information concerning the main signal, and transmits the control signal Sc including the setting information to the second transmission device. The second transmission device 9 receives the control signal Sc, and sets the frame processing section 20 in accordance with the setting information included in the control signal Sc.

The above-described transmission method is executed using a configuration substantially the same as or similar to the configuration of the transmission device 9 illustrated in FIG. 1 or 5. Thus, effects substantially the same as or similar to the above-described effects may be achieved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission device that receives a main signal, the transmission device comprising:
a receiver configured to receive, from a different transmission device corresponding to a source device of the main signal, a control signal including setting information concerning the main signal;
a frame processing section configured to process a frame of the main signal; and
a first controller configured to set the frame processing section in accordance with the setting information.

2. The transmission device according to claim 1, wherein the control signal is superimposed on the main signal.

3. The transmission device according to claim 1, further comprising,
an error correction section configured to perform error correction on data of the main signal based on an error correction code included in the main signal,
wherein the control signal includes code-type information indicating a type of error correction code, and
wherein the first controller sets the error correction section in accordance with the code-type information.

4. The transmission device according to claim 1, further comprising,
a light source configured to output a reference light beam whose wavelength is variable,
wherein the receiver detects the control signal using the reference light beam, and
wherein the first controller controls the wavelength of the reference light beam so that a power of the control signal becomes equal to or larger than a value.

5. The transmission device according to claim 1, wherein the different transmission device comprises:
a frame generator configured to generate a frame of the main signal;
a second controller configured to set the frame generator in accordance with setting information concerning the main signal, and generate a control signal including the setting information; and
a transmitter configured to transmit the control signal.

6. The transmission device according to claim 5, wherein the transmitter superimposes the control signal on the main signal, and transmits a superimposed signal.

7. The transmission device according to claim 5, further comprising,
an error-correction-code generator configured to generate an error correction code for a correction of an error in data of the main signal,
wherein the control signal includes code-type information indicating a type of error correction code, and
wherein the second controller sets the error-correction-code generator in accordance with the code-type information.

8. A transmission device that transmits a main signal, the transmission device comprising:
a frame generator configured to generate a frame of the main signal;
a first controller configured to set the frame generator in accordance with setting information concerning the main signal, and generate a control signal including the setting information; and
a transmitter configured to transmit the control signal to a different transmission device corresponding to a destination device of the main signal.

9. The transmission device according to claim 8, wherein the transmitter superimposes the control signal on the min signal, and transmits a superimposed signal.

10. The transmission device according to claim 8, further comprising,
an error-correction-code generator configured to generate an error correction code for a correction of an error in data of the main signal,
wherein the control signal includes code-type information indicating a type of error correction code, and
wherein the first controller sets the error-correction-code generator in accordance with the code-type information.

11. The transmission device according to claim 8, wherein the different transmission device comprises:
a receiver configured to receive the control signal including setting information concerning the main signal;
a frame processing section configured to process the frame of the main signal; and
a second controller configured to set the frame processing section in accordance with the setting information.

12. The transmission device according to claim 11, wherein the control signal is superimposed on the main signal.

13. The transmission device according to claim 11, further comprising,
an error correction section configured to perform error correction on data of the main signal based on an error correction code included in the main signal,
wherein the control signal includes code-type information indicating a type of error correction code, and
wherein the second controller sets the error correction section in accordance with the code-type information.

14. The transmission device according to claim 11, further comprising,
a light source configured to output a reference light beam whose wavelength is variable,
wherein the receiver detects the control signal using the reference light beam, and
wherein the second controller controls the wavelength of the reference light beam so that a power of the control signal becomes equal to or larger than a value.

15. A transmission method comprising:
receiving, from a transmission device, a frame of a main signal and a control signal including setting information concerning the main signal;
setting a frame processing section for the main signal in accordance with the setting information; and
processing the frame of the main signal by the frame processing section.

16. The transmission method according to claim 15, wherein the control signal superimposed on the main signal is received.

17. The transmission method according to claim 15, further comprising:
generating an error correction code for a correction of an error in data of the main signal;
receiving the control signal including code-type information indicating a type of error correction code;
setting an error correction section in accordance with the code-type information; and
correcting the error in the data of the main signal based on the error correction code with the error correction section.
